(19) United States
(12) Patent Application Publication
(10) Pub. No.: US 2026/0148646 A1
(43) Pub. Date: May 28, 2026

(54) AIRCRAFT TAKEOFF MANAGEMENT SYSTEM

(71) Applicant: Honeywell International Inc., Charlotte, NC (US)

(72) Inventors: Ravikumar Selvarajan, Madurai (IN); Raghu Seelamonthula, Dubai (AE); Sreenivasan K. Govindillam, Bengaluru (IN)

(21) Appl. No.: 19/053,088

(22) Filed: Feb. 13, 2025

(30) Foreign Application Priority Data
Nov. 25, 2024 (IN) 202411091760

(51) Int. Cl. G08G 5/52; B64D 45/00; G08G 5/265; G08G 5/30; G08G 5/56; G08G 5/72

(52) U.S. Cl. CPC G08G 5/52; B64D 45/00; G08G 5/265; G08G 5/30; G08G 5/56; G08G 5/727; B64D 2045/0075

(57) ABSTRACT

A system for coordinating takeoff of a first aircraft and a second aircraft receives, from a first computing device of the first aircraft, first flight data for the first aircraft; determines a separation distance between the first aircraft and the second aircraft based on the first flight data; receives, from a second computing device of the second aircraft, second flight data for the second aircraft; determines a runway takeoff length for the second aircraft based on the second flight data; selects, from a plurality of ingress points for a runway, an ingress point for the second aircraft based on the separation distance and the runway takeoff length; and transmits an indication of the ingress point to the second aircraft.

This application claims the benefit of Indian Provisional Patent Application No. 202411091760, filed Nov. 25, 2024, the entire contents of which are incorporated herein by reference.

### TECHNICAL FIELD

This disclosure relates to systems for determining takeoff locations and separation distances for aircraft taking off on a runway.

### BACKGROUND

An Airport Collaborative Decision Making (ACDM) system is a system used by airports to improve the efficiency, safety, and predictability of operations of the airport by sharing and integrating information among key stakeholders involved in airport operations. These stakeholders typically include air traffic control (ATC), airlines, ground handling teams, airport operations, and other relevant entities. An ACDM system aims to optimize decision-making and resource utilization.

### SUMMARY

This disclosure describes a system configured to select between multiple ingress options and send instructions to aircraft to enter the runway at a point where there is still a sufficient amount of runway length available for a safe takeoff safely. The system of this disclosure may reduce the average waiting time and fuel burned during taxiing, which lowers fuel and operation costs for the airport and improves the overall efficiency of the airport.

According to an example of this disclosure, a computer-implemented method for coordinating takeoff of a first aircraft and a second aircraft includes receiving, from a first computing device of the first aircraft by processing circuitry of a runway management system, first flight data for the first aircraft; determining, by the processing circuitry of the runway management system, a separation distance between the first aircraft and the second aircraft based on the first flight data; receiving, from a second computing device of the second aircraft by the processing circuitry of the runway management system, second flight data for the second aircraft; determining, by the processing circuitry of the runway management system, a runway takeoff length for the second aircraft based on the second flight data; selecting, from a plurality of ingress points for a runway, an ingress point for the second aircraft based on the separation distance and the runway takeoff length; and transmitting an indication of the ingress point to the second aircraft.

According to another example of this disclosure, a system for coordinating takeoff of a first aircraft and a second aircraft includes one or more memories; and processing circuitry coupled to the one or more memories and configured to receive, from a first computing device of the first aircraft, first flight data for the first aircraft; determine a separation distance between the first aircraft and the second aircraft based on the first flight data; receive, from a second computing device of the second aircraft, second flight data for the second aircraft; determine a runway takeoff length for the second aircraft based on the second flight data; select, from a plurality of ingress points for a runway, an ingress point for the second aircraft based on the separation distance and the runway takeoff length; and transmit an indication of the ingress point to the second aircraft.

According to another example of this disclosure, an avionics system configured to be mounted on an aircraft includes one or more memories and processing circuitry coupled to the one or more memories and configured to receive, via an input device, first flight plan data, wherein the first flight plan data configures a flight management system of the avionics to cause the aircraft to follow a flight path defined by the first flight plan data; determine second flight plan data based on the first flight plan data, wherein the second flight plan data comprises one or more indicators of a takeoff weight of the aircraft; transmit the second flight plan data to an external computing system; in response to transmitting the second flight data, receiving from the external computing system, an ingress point for a runway; and cause a display to output an airport map, wherein the airport map includes an annotation indicating the ingress point.

The details of one or more examples are set forth in the accompanying drawings and the description below. Other features, objects, and advantages will be apparent from the description, drawings, and claims.

### BRIEF DESCRIPTION OF DRAWINGS

FIG. 1 shows an overview of an example computing environment in which techniques of the present disclosure may be implemented.

FIG. 2A shows an example layout of an airport from a top-down perspective.

FIG. 2B shows an example takeoff sequencing pattern for the runway of FIG. 2A.

FIG. 3 illustrates an example of an airport collaborative decision making system in accordance with techniques of this disclosure.

FIG. 4 shows an example of a computing device for executing EFB applications in accordance with techniques of this disclosure.

FIG. 5 shows an example of an avionics system in accordance with techniques of this disclosure.

FIG. 6 is a diagram of an example graphical output display of an airport ground surface map.

FIG. 7 is a flowchart showing an example process for selecting an ingress point for a runway from a plurality of available ingress points.

Throughout the figures, like reference numerals across multiple figures refer to the same hardware, software, data, step, etc.

### DETAILED DESCRIPTION

The efficient usage of runways and taxiways during takeoffs can be a problem for busy airports. Often times, aircraft will keep lining up on the ground to get access to the runway but must wait for other aircraft to complete takeoff first. More time spent lining up and waiting increases fuel consumption, and hence results in more cost, noise, and emissions due to engines running and burning fuel while in the taxiway. Time lined up waiting for a runway also potentially increases delays and engine running time, creates slot reservation problems, and lessens the predictability of airport operation.

The taxi and holding times experienced by aircraft are affected by weather patterns along with the dynamic wake turbulence. These factors and others determine the separation that needs to be maintained between successive takeoffs and landings based on the airframe of the aircraft taking off and landing.

Another source of delay relates to runway ingress points. Irrespective of aircraft performance needs and the various ingress options available at an airport, aircraft are often made to ingress via either of the end points of the runway, even if the runways have other available ingress points. Aircraft are always made to go to the end of the runway because the runway and taxiway scheduling systems do not have information about the dynamic runway length needed for a given aircraft. There is a need to bring this information into the airport collaborative decision making systems, like dispatch systems, so that the systems can more efficiently manage the runway and taxiway operations of the aircraft.

Most runways are designed to handle a wide range of aircraft with different performance characteristics. Smaller aircraft, such as an ATR 72, need just 1300 meters of runway to take off, while larger aircraft, such as A380 and 747-8, need around 3000 m. Large Airports, such as Ohare or Heathrow, typically have runway lengths above 3500 meters, but a large portion of the traffic at such airports still only need less than 1850 meters. Depending on the payloads for a particular flight, the runaway length requirement may be even smaller.

This disclosure describes a system configured to select between multiple ingress options and send instructions to aircraft to enter the runway at a point where there is still a sufficient amount of runway length available for a safe takeoff safely. The system of this disclosure may reduce the average waiting time and fuel burned during taxiing, which lowers fuel and operation costs for the airport and improves the overall efficiency of the airport.

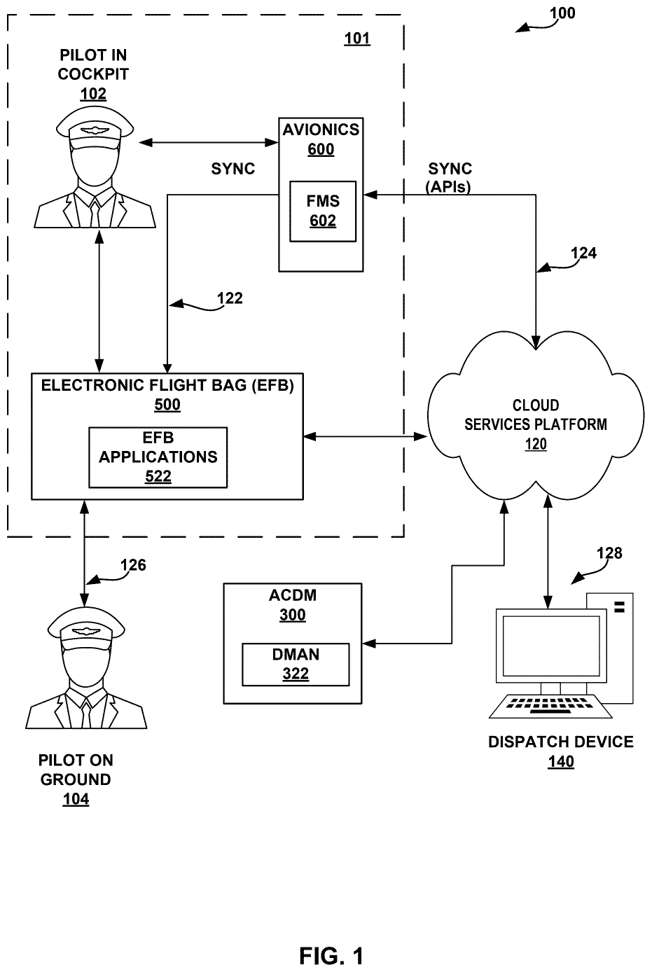

FIG. 1 shows an overview of an example computing environment 100, according to one or more examples of the present disclosure. In environment 100, EFB 400 is configured to communicate with avionics 500. EFB 400 and avionics 500 are both devices or systems that may be located inside aircraft 101. Environment 100 also includes a connected cloud services platform 120 (platform 120) and a dispatcher device 140, which may be located outsider of aircraft 101. One of the services available via platform 120 may be an airport collaborative decision making system 300 (ACDM 300) that includes a departure manager (DMAN 322 in FIG. 1).

EFB 400 may be a computer device carried by a pilot or a flight crew, which may store, for example, navigational charts, maps for air and ground operations of an aircraft, a flight plan management system, an aircraft operating manual, flight-crew operating manual, software applications which automate flight-related or avionics-related computation tasks, and/or any application or data which may be installed in a general purpose computing platform. EFB 400 may include a pilot information display (PID). As part of performing the techniques of this disclosure, EFB 400 may be configured to provide flight data to ACDM 300.

Avionics 500 generally represents any electronic systems that may be implemented in an aircraft. Avionics 500 may, for example, perform functions related to communication, navigation, safety monitoring, and other such functionality. Avionics 500 includes FMS 502, which represents a specialized computer system configured to automate in-flight tasks according to a flight plan. As part of performing the techniques of this disclosure, avionics 500 may be configured to provide flight data to ACDM 300.

Dispatcher device 140 may be any computer device which may be accessed by a user who performs planning, flying, navigating, or managing tasks associated with aircraft, airspaces, airports, or flight plans. Accordingly, the user is not limited to a dispatcher, and the dispatcher device 140 is not limited to a device of a dispatcher. The connected FMS cloud services platform 120 may be a cloud-based platform that provides FMS services to any user who has authorized access to the platform.

As shown in FIG. 1, the environment 100 may accommodate access by various types of users. For example, a pilot 102, who may be in cockpit, may have access to EFB 400 and EFB applications 422 installed on EFB 400. Pilot 102 may also have access to avionics 500 and FMS 502, through which pilot 102 may access the connected FMS cloud services platform 120. EFB applications 422 may access connected FMS cloud services platform 120 and provide the FMS services to the users of EFB 400 in which the EFB applications 422 are installed. In that way, EFB 400 may provide to pilot 102 user-friendly and customized user interfaces, by which pilot 102 may interact with FMS services from the platform 120.

FMS 502 may also be configured to synchronize data 124 with connected FMS cloud services platform 120, using, for example, an application programming interface (API). In addition, FMS 502 may also be configured to synchronize data 122 with EFB applications 422. Thus, in some implementations, FMS 502 may be synchronized with data from both EFB 400 and platform 120 in real-time or at predetermined intervals, in such a way that the pilot 102 may rely on the on-board FMS 502 for all tasks arising in the environment 100.

A pilot 104, who may be on the ground, may also access EFB 400 and the EFB applications 422. In some implementations, the pilot 104 and the pilot on cockpit 102 may be the same pilot, yet under different circumstances (e.g., time and location of the access). Additionally, or alternatively, the pilot 104 may be a different pilot, or another authorized member of the flight crew, who accesses EFB 400 on the ground for an official duty related to the connected FMS cloud services platform 120. While pilot 104 is accessing the EFB applications 422 via EFB 400, the EFB applications 422 may access the connected FMS cloud services platform 120 to receive various FMS services. In that way, EFB 400 may provide user-friendly and customized user interfaces, by which FMS services 126 from the connected FMS cloud services platform 120 may be serviced to pilot 104.

A dispatcher or other user may also access the connected FMS cloud services platform 120 through a dispatcher device 140. A dispatcher, in accordance with the present disclosure, may be any authorized personnel performing duties related to dispatching of aircraft in the environment 100. For example, a dispatcher may be an airline staff, an airport staff, air traffic control personnel, a ground control personnel, a member of a relevant aviation authority, or any other authorized person who may benefit from FMS services from the connected FMS cloud services platform 120 in performing their duties. Dispatcher device 140 may be any computing device capable of establishing a connection 128 to the cloud and interfacing with the connected FMS cloud services platform 120. While the dispatcher is accessing the FMS services via the dispatcher device 140, the dispatcher device 140 may access the connected FMS cloud services platform 120 to receive various FMS services. In that way, the dispatcher device 140 may provide user-friendly and customized user interfaces, by which FMS services from the connected FMS cloud services platform 120 may be serviced to the dispatcher.

FMS 502, EFB 400, and dispatcher device 140 may include one or more devices capable of receiving, generating, storing, processing, and/or providing information associated with FMS services. For example, FMS 502, EFB 400, or the dispatcher device 140 may include a communication and/or computing device, such as a mobile phone (e.g., a smart phone, a radiotelephone, etc.), a computer (e.g., a desktop computer, a laptop computer, a tablet computer, a handheld computer), a gaming device, a wearable communication device (e.g., a smart wristwatch, a pair of smart eyeglasses, etc.), or a similar type of device.

As part of facilitating communication between any of avionics 500, EFB 400, or FMS cloud services platform 120, the systems and devices may be configured to transmit and receive flight plans in the form of a .RTE (route) file, a .FPL (flight plan) file, or other file formats.

A .RTE file is a standard file format that may be used by FMS 502 and EFB applications 422 to store and exchange flight planning data. As will be illustrated in more detail below, .RTE files include some or all of sections for flight information, route details, altitude and speed information, fuel information, performance data, weather information, and other notes or remarks of interest to a pilot or other user. Each section then includes a field name and a value for the field name. A non-exhaustive list of fields that may be included in a .RTE file are FLIGHT_NUMBER, AIRCRAFT_TYPE, DEPARTURE_AIRPORT, DESTINATION_AIRPORT, ESTIMATED_DEPARTURE_TIME, ESTIMATED_ARRIVAL_TIME, WAYPOINTS, AIRWAYS, DEPARTURE_PROCEDURE, ARRIVAL_PROCEDURE, CRUISING_ALTITUDE, CLIMB_PROFILE, DESCENT_PROFILE, TOTAL_FUEL, TRIP_FUEL, RESERVE_FUEL, TAKEOFF_WEIGHT, LANDING_WEIGHT, ZERO_FUEL_WEIGHT, DEPARTURE_WEATHER, ARRIVAL_WEATHER, ENROUTE_WEATHER, PILOT_REMARKS, OPERATIONAL_NOTES.

Pilots (e.g., pilots 102 and 104) and dispatcher (e.g., a user of dispatch device 140) may may use . RTE files to plan and file flight routes and ensure compliance with air traffic control and safety regulations. A .RTE file may be uploaded from EFB 400 to FMS 502 to provide necessary flight details for navigation and management during the flight. The interoperability of .RTE files may facilitate sharing of flight plans between different systems and stakeholders (e.g., airlines, airports, air traffic control). Instead of or in addition to .RTE files, FMS 502 and EFB applications 422 may exchange .FPL (flight plan) files, which include similar information as .RTE files and are used for similar purposes as .RTE files, but have a different formatting.

ACDM 300 may be configured to receive data from a plurality of sources, such as airlines, air traffic control, airport operators, ground handling teams, national or regional air traffic management agencies, and the like. ACDM 300 may be configured to streamline processes like aircraft turnaround, ground handling, and airspace management, as well as maximizing the use of gates, taxiways, runways, and other airport resources. In accordance with the techniques of this disclosure, ACDM 300 includes a departure manager application 322 configured to perform pre-departure sequencing to optimize the sequence of departing aircraft to improve runway throughput and minimize waiting times.

ACDM 300 may be configured to compute and provide an optimal ingress point for an aircraft into the runway so that the aircraft can make use of an adequate amount of runway length for takeoff based on take-off performance requirements. In some examples, instead of going all the way to the end of the runway for doing take off, ACDM 300 may select an ingress point in between the end points. ACDM 300 may implement a taxiway traffic handling algorithm with real time takeoff length needs for each of the aircraft scheduled to takeoff from a given runway and scheduling time milestones.

FMS 502 in aircraft 101 may be configured to determine takeoff performance characteristics for a given flight, depending on the aircraft type, engine type, aircraft performance, payload for the day, runway atmospheric conditions, elevations, etc. Based on all this information, FMS 502 may calculate what is the length of the runway needed to take off safely and at what speed the pilot has to abort (V1), rotate (VR), and maintain cross the immediate clearance (V2), etc. In accordance with the techniques of this disclosure, ACDM 300 may receive this information from avionics 500.

ACDM 300 may be configured to determine an optimal dynamic separation. Aircrafts are scheduled for runway usage in such a way that there is a separation between two consecutive aircrafts sufficient for the second aircraft to not get affected by the wake turbulence generated by the preceding aircraft. This is typically determined based on the aircraft type. For example, a heavy jet behind a super jet may require 6 miles, whereas a large jet behind a super jet may require 7 miles. As smaller aircraft tend to be more affected by wake turbulence, a small jet behind a super jet may require 8 miles. A heavy jet behind another heavy jet may require 4 miles, while a small jet behind a heavy jet requires 5 miles.

These separation distances are based on an assumption that the preceding aircraft is fully loaded, which may not always be the case. For example, a heavy jet may have a maximum takeoff weight of 300,000 pounds, but the actual takeoff weight may be less than the maximum. A super jet may have a maximum takeoff weight significantly larger than that of a heavy jet. By receiving dynamic performance information of an aircraft (e.g., takeoff weight) from avionics 500, ACDM 400 may use a wake turbulence model to determine a magnitude of the wake turbulence that would be generated and hence the real separation required for a second aircraft taking off behind the first aircraft. For example, a heavy jet behind a fully loaded super jet might need to maintain separation of 6 miles, but if the super jet is only lightly loaded, then the real need might be only 4 miles. By reducing this separate by two miles, DMAN 322 may be able to include more takeoffs within a time window. By knowing the dynamic performance details of participating aircraft, DMAN 322 may be configured utilize dynamic separation, i.e., non-fixed separation, to optimize runway usage.

As indicated above, FIG. 1 is provided merely as an example. Other examples are possible and may differ from what was described with regard to FIG. 1. The number and arrangement of devices and networks shown in FIG. 1 are provided as an example. In practice, there may be additional devices, fewer devices and/or networks, different devices and/or networks, or differently arranged devices and/or networks than those shown in FIG. 1. Furthermore, two or more devices shown in FIG. 1 (e.g., EFB 400 and dispatcher device 140) may be implemented within a single device, or a single device shown in FIG. 1 (e.g., EFB 400, FMS 502, or dispatcher device 140) may be implemented as multiple, distributed devices. Additionally, or alternatively, a set of devices (e.g., one or more devices) of environment 100 may perform one or more functions described as being performed by another set of devices of environment 100.

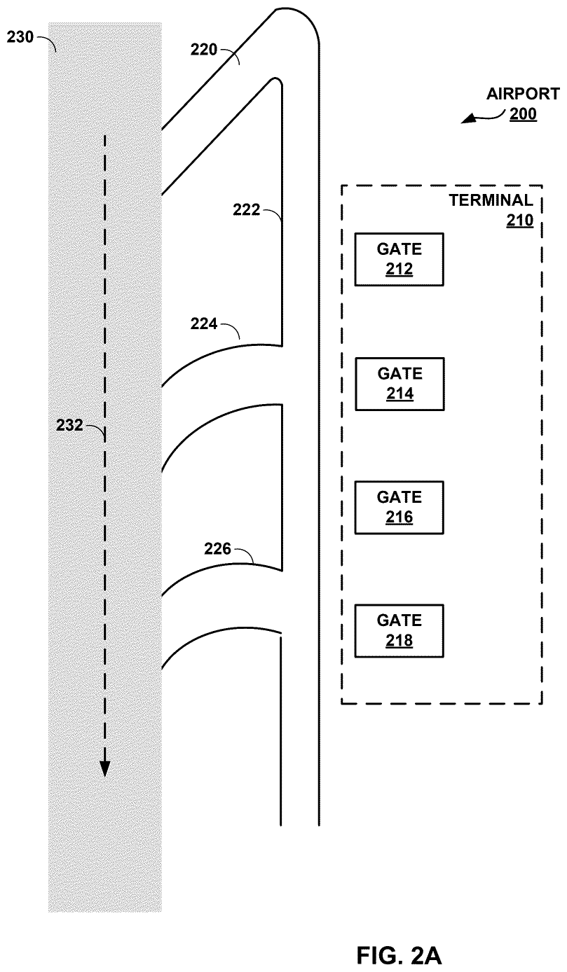

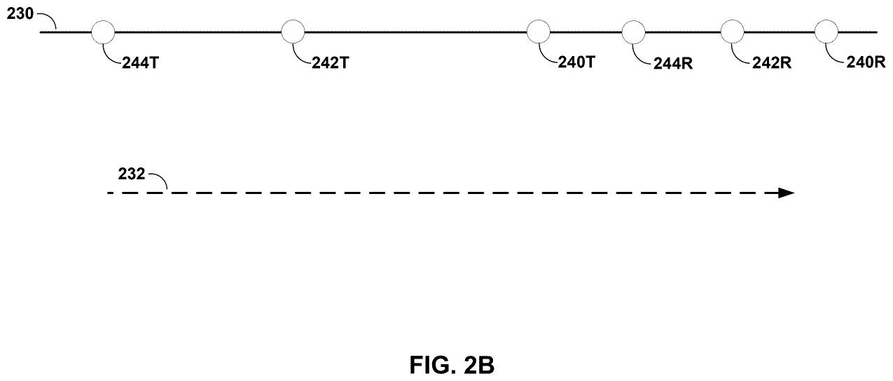

FIG. 2A shows an example layout of airport 200 from a top-down perspective. Airport 200 includes terminal 210 with gates 212, 214, 216, and 218. Airport 200 also includes taxiways 220, 222, 224, and 226 as well as runway 230. Each of taxiways 220, 224, and 226 may correspond to a different ingress point for runway 230. Planes may take off on runway 230 in the direction of arrow 232. That is traffic on runway 230 may flow from a first end to a second end, with taxiway 220 being closer to the first end and further from the second end than are taxiways 224 and 226.

Rather than defaulting to a set a separation distance based on a maximum takeoff weight, departure manager application 322 may be configured to receive from a first computing device of a first aircraft, first flight data for the first aircraft and determine a separation distance required between the first aircraft and a second aircraft taking off after the first aircraft. Departure manager application 322 may receive, from a second computing device of the second aircraft, second flight data for the second aircraft and determine a runway takeoff length for the second aircraft based on the second flight data. Departure manager application 322 may select, from a plurality of ingress points for runway 230, an ingress point for the second aircraft based on the separation distance and the runway takeoff length. For example, rather than always defaulting to the ingress point of taxiway 220, departure manager application 322 may select any of the ingress points associated with taxiway 220, taxiway 224, or taxiway 226.

Departure manager application 322 may, for example, be configured to determine, based on the first flight data, a takeoff weight of the first aircraft and determine the separation distance based on the takeoff weight of the first aircraft. The takeoff weight determined for the first aircraft may be an actual takeoff weight rather than a maximum takeoff weight. The first aircraft may have an actual takeoff weight below the maximum takeoff weight if the aircraft has a smaller than usual payload, such as fewer passengers and/or less cargo, or if the aircraft is flying with less than a full tank of fuel.

Departure manager application 322 may input the takeoff weight into a wake turbulence model that correlates the takeoff weight with an amount of wake turbulence generated. The wake turbulence model may, for example, be specific to an aircraft type or account for an aircraft design and shape. For example, aircraft with high-aspect-ratio wings (e.g., long and narrow) tend to generate weaker wake turbulence because the lift is more evenly distributed along the wing span, while aircraft with low-aspect-ratio wings (e.g., short and wide) concentrate lift near the wing roots, creating stronger, more concentrated vortices. Some aircraft may include winglets, e.g., vertical or angled extensions at the wingtips, that reduce the strength of wake vortices by preventing high-pressure air under the wing from spilling over the wingtips into the low-pressure area above. Additionally, wing-mounted engines may produce a different wake turbulence profile than fuselage-mounted engines.

The wake turbulence model may also account for the weather in which the first aircraft took off. Departure manager application 322 may, for example, obtain weather data from a weather source, such as an automated weather observing system or an automated surface observing system at the airport. Departure manager application 322 may additionally or alternatively obtain the weather data, via a network for example, from a source not located at airport 200. The wake turbulence model may correlate the weather data, in conjunction with the actual weight of the first aircraft, to an amount and profile of wake turbulence created by the second aircraft. For example, if an aircraft takes off into a headwind, then the wake turbulence may remain closer to the runway for longer than if the aircraft takes off with a tailwind. As another example, at high temperatures, air density decreases, which requires aircraft to generate more lift to achieve takeoff, resulting in stronger wake vortices due to more lift generates more intense vortex formation. In contrast, at lower temperatures with denser air, lift is easier to generate, which might lead to weaker vortices. As another example, rain may cause wake turbulence to dissipate faster.

Departure manager application 322 may also select the ingress point for the second aircraft based on a roll point for the second aircraft. For example, if the second aircraft begins takeoff from the middle of the runway and reaches a roll point at the end of the runway, then another aircraft that begins takeoff farther back on the runway and reaches a roll point before the roll point of the first aircraft may be able to take off with a reduced separation distance than if both aircraft began takeoff at the same point on the runway. By having a roll point behind the roll point of the second aircraft, the second aircraft may be able to reduce an amount of wake turbulence encountered by flying over the wake turbulence or at least flying over the most concentrated areas of wake turbulence.

Departure manager application 322 may also be configured to determine a set of taxi instructions based on the ingress point and transmit the set of taxi instructions to the second aircraft. The taxi instructions may, for example, indicate which of taxiways 220, 222, 224, and 226 the second aircraft is supposed to use to access the selected ingress point.

Departure manager application 322 may also be configured to generate milestone times in conjunction with the taxi instructions. The milestone times may, for example, be dependent on the selected ingress point. For instance, if departure manager application 322 selects a relatively close ingress point, such as taxiway 226 for a plane at gate 218, then departure manager application 322 may reduce an estimated time to taxi from the gate to the runway threshold or delay a time the aircraft pushes back from the gate. As another example, if departure manager application 322 selects a an ingress point that enables the aircraft to utilize a shorter separation distance, then departure manager may move sooner a target time for the aircraft to lift off from the runway.

FIG. 2B shows an example takeoff sequencing pattern for runway 230. FIG. 2B shows a series of thresholds and roll points. A threshold generally corresponds to the point on the runway where the aircraft begins moving down the runway for takeoff, and a roll point generally corresponds to the point where the aircraft is at a full takeoff thrust and beginning to elevate off the ground. In some cases, the roll point may correspond to a point at which the aircraft achieves a certain speed or acceleration or a point at which a specific amount of takeoff thrust is being exerted.

A first aircraft that requires a relatively short runway takeoff length may begin takeoff from threshold 240T and begin lifting off at roll point 240R. The first aircraft may, for example, ingress runway 230 via taxiway 226, such that the first aircraft begins takeoff closer to the middle of runway 230 rather than at a far end of runway 230. By beginning takeoff at a threshold 240T, as opposed to threshold 244T for example, the first aircraft may have reduced taxing time and distances, which saves time and fuel and reduces operational wear on the aircraft. Additionally, having the first aircraft begin takeoff at threshold 240T rather than threshold 244T gives a takeoff scheduler, e.g., departure manager application 322, additionally flexibility, such as the ability to have the first aircraft takeoff before another aircraft even if the other aircraft pulls back from a gate sooner or reaches a threshold sooner.

A second aircraft that requires a longer runway takeoff length than the first aircraft may begin takeoff from threshold 242T and begin lifting off at roll point 242R. The second aircraft may, for example, ingress runway 230 via taxiway 224, such that the first aircraft begins takeoff farther back than the first aircraft but still closer to the middle of runway 230 rather than at a far end of runway 230.

As roll point 242R for the second aircraft is farther back than roll point 240R for the first aircraft, departure manager application 322 may reduce a separation distance required between the first aircraft and the second aircraft because, due in part to an earlier roll position, the second aircraft may be able to elevate above the wake turbulence caused by the first aircraft or at least avoid the most severe wake turbulence generated by the first aircraft.

A third aircraft that requires an even longer runway takeoff length than the second aircraft may begin takeoff from threshold 244T and begin lifting off at roll point 244R. The second aircraft may, for example, ingress runway 230 via taxiway 220, such that the third aircraft begins takeoff at a far end of runway 230.

As roll point 2424 for the second aircraft is farther back than roll point 242R for the first aircraft, departure manager application 322 may reduce a separation distance required between the second aircraft and the third aircraft because, due in part to an earlier roll position, the third aircraft may be able to elevate above the wake turbulence caused by the second aircraft or at least avoid the most severe wake turbulence generated by the second aircraft. By using this sequencing of takeoffs and by using multiple ingress points onto runway 230, departure manager application 322 may reduce the separation distances between the aircrafts, and hence reduce the amount of time between takeoffs, which enables more takeoff within any given time period.

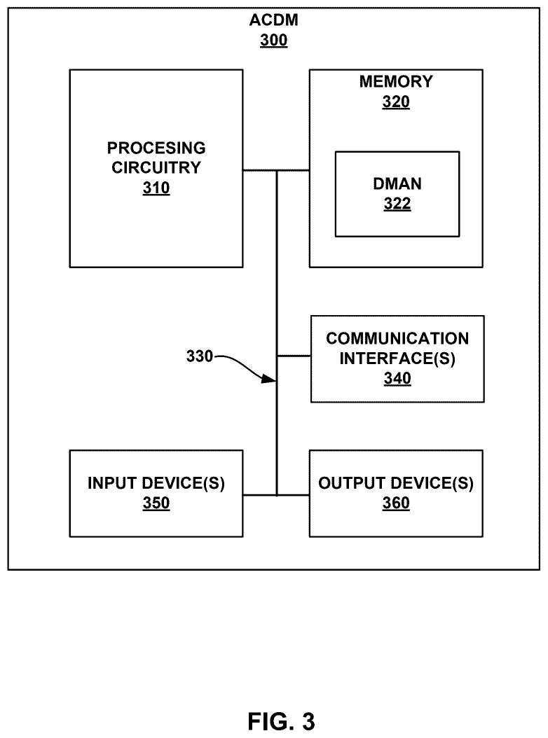

FIG. 3 illustrates an example of ACDM 300. ACDM 300 represents generic computing hardware configured to store and execute flight data obfuscation engine 322. In the example of FIG. 3, ACDM 300 includes processing circuitry 310, memory 320 which stores departure manager application 322, communication interface(s) 340, input device(s) 350, and output device(s). The aforementioned components of ACDM 300 may be connected to one another through a bus 330, which generally represents one or more busses and is intended to generically represent all the electrical and data connectivity of internal components included within ACDM 300.

Processing circuitry 310 implements the functionality of and/or executes the instructions associated with departure manager application 322. Processing circuitry 310 may be implemented as any of a variety of suitable circuitry that includes a processing system, such as one or more integrated circuits, microprocessors, digital signal processors (DSPs), application specific integrated circuits (ASICs), field programmable gate arrays (FPGAs), discrete logic, software, hardware, firmware or any combinations thereof. When the techniques are implemented partially in software, ACDM 300 may store instructions for the software in a suitable, non-transitory computer-readable medium (e.g., memory 320) and execute the instructions in hardware using processing circuitry 310 to perform the techniques of this disclosure.

Memory 320 is intended to generically represent all memory included within ACDM 300. In some implementations, memory 320 may include a plurality of separate devices and memory units. These memory devices and memory units may include volatile memory, such as random access memory (RAM), and/or non-volatile memory, such as ROM and storage media. Example of RAM include dynamic random access memory (DRAM), including synchronous DRAM (SDRAM), magnetoresistive RAM (MRAM), resistive RAM (RRAM). Examples of storage media include solid-state storage media (e.g., solid state drives and/or removable flash memory), optical storage media (e.g., optical discs), and/or magnetic storage media (e.g., hard disk drives).

Communication interface(s) 340 generally represents all hardware, e.g., transceiver circuitry, within ACDM 300 for communicating with external devices. Communication interface(s) 340 may facilitate communication with external devices via one or more wired and/or wireless network connections by transmitting and/or receiving signals on the one or more networks. Examples of communication interface(s) 340 include a network interface card (e.g., such as an Ethernet card or WiFi card), an optical transceiver, a radio frequency transceiver, or any other type of device that can send and/or receive information. Other examples of communication interface(s) 340 may include short wave radios, cellular data radios, wireless network radios, as well as USB controllers.

ACDM 300 also includes input device(s) 350 (e.g., a keyboard, mouse, or touchscreen) and output device(s) 360 (e.g., a display, printer). The various examples of input and output devices listed above represent a non-exhaustive list of the types of the types of input and output devices that may be included in input device(s) 350 and output device(s) 360.

Processing circuitry 310 may be configured to receive, via communication interface(s) 440 for a flight, flight data that includes flight identification data and parameter data obtained from a flight data recorder of an aircraft.

Although ACDM 300 is shown in the example of FIG. 3 as being a single device, in many implementations, the functionality attributed to ACDM 300 may be performed across multiple devices. For example, one device may receive and modify the flight data, while a different device receives the flight analysis data for the modified flight data, associates the flight analysis data with the flight identification data, and generates a dashboard based on the flight analysis data and the flight identification data.

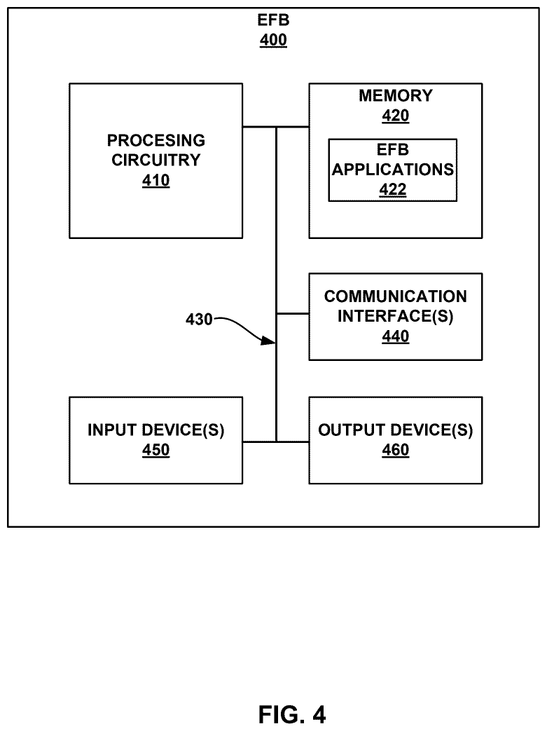

FIG. 4 illustrates an example of EFB 400. EFB 400 may be any sort of generic computing hardware, such as a tablet computer, phone, laptop computer, desktop computer, or other such computing device, that is configured to store and execute EFB applications. In other examples, EFB 400 may be specialized computing hardware configured to store and execute EFB applications. Some EFBs may be portable and be able to be carried from plane to plane, while other EFBs may be permanently mounted in a specific airplane. In the example of FIG. 4, EFB 400 includes processing circuitry 410, memory 420 which stores EFB applications 422 and communication interface(s) 440 to communicate with other devices.

Processing circuitry 410 implements the functionality of and/or executes the instructions associated with EFB applications 422. Processing circuitry 410 may be implemented as any of a variety of suitable circuitry that includes a processing system, such as one or more integrated circuits, microprocessors, DSPs, ASICs, FPGAs, discrete logic, software, hardware, firmware or any combinations thereof. When the techniques are implemented partially in software, EFB 400 may store instructions for the software in a suitable, non-transitory computer-readable medium (e.g., memory 420) and execute the instructions in hardware using processing circuitry 410 to perform the techniques of this disclosure.

Memory 420 is intended to generically represent all memory included within EFB 400. In some implementations, memory 420 may include a plurality of separate devices and memory units. These memory devices and memory units may include volatile memory, such as RAM), and/or non-volatile memory, such as ROM and storage media. Example of RAM include DRAM, including SDRAM, MRAM, RRAM. Examples of storage media include solid-state storage media (e.g., solid state drives and/or removable flash memory), optical storage media (e.g., optical discs), and/or magnetic storage media (e.g., hard disk drives). The aforementioned EFB application (shown in FIG. 4 as EFB applications 422) may be stored in any volatile and/or non-volatile memory component of memory 420.

EFB 400 also includes input device(s) 450 (e.g., a keyboard, mouse, or touchscreen) and output device(s) 460 (e.g., a display, printer). In implementations where EFB 400 is a phone or tablet computer, then the EFB may, for example, have a touchscreen and a display. In implementations where EFB 400 is a larger computer device, then the EFB may, for example, have a mouse, trackpad, keyboard, or other such input devices. The aforementioned components of EFB 400 may be connected to one another through a bus 430, which generally represents one or more busses and is intended to generically represent all the electrical and data connectivity of internal components included within EFB 400.

Communication interface(s) 440 generally represents all hardware, e.g., transceiver circuitry, within EFB 400 for communicating with external devices. Communication interface(s) 440 may facilitate communication with external devices via one or more wired and/or wireless network connections by transmitting and/or receiving signals on the one or more networks. Examples of communication interface(s) 440 include a network interface card (e.g., such as an Ethernet card), an optical transceiver, a radio frequency transceiver, a GPS receiver, or any other type of device that can send and/or receive information. Other examples of communication interface(s) 344 may include short wave radios, cellular data radios, wireless network radios, as well as universal serial bus (USB) controllers. In some examples, communication interface(s) 344 may include an avionics full-duplex switched ethernet (AFDX) interface, also known as ARINC 664.

EFB applications 422 represent a suite of software tools that may be used by a pilot in managing flight operations. EFB applications 422 may include flight planning applications that allow pilots to create and file flight plans, access weather information, and calculate fuel requirements. EFB applications 422 may also include navigation applications that provide real-time navigation support with maps, airspace information, and waypoint management. EFB applications 422 may also include weather applications that provide real-time weather data, future weather predictions, radar imagery, and the like. EFB applications 422 may also include checklist applications for ensuring compliance with pre-flight, mid-flight, and post-flight procedures. EFB applications 422 may also include various performance analysis tools that, for example, help pilots compute takeoff and landing distances based on current conditions and aircraft configuration. EFB applications 422 may also include aircraft maintenance tracking tools that track aircraft maintenance schedules, inspection records, and compliance records. EFB applications 422 may also include flight logbooks that enable pilots to log flights, track hours, and generate reports for currency and certification. EFB applications 422 may also include airport information applications that provide information about airports, including runway layouts, services, and notices.

The various example applications listed above represent a non-exhaustive list of the types of applications that may be included in EFB applications 422. As explained above, some applications of EFB applications 422 may facilitate communication with avionics 500 using the data communication techniques of this disclosure.

Processing circuitry 410 may be configured to receive, via input device(s) 450, first flight plan data. The flight plan data may, for example, be flight plan data intended to be executed by FMS 502. The first flight plan data may, for example, be in the form of a .RTE or .FPL file. Processing circuitry 410 determines second flight plan data based on the first flight plan data. The second flight plan data may, for example, include one or more indicators of a takeoff weight of the aircraft. Processing circuitry 410 may extract the one or more indicators from values in the .RTE or .FPL file. Processing circuitry 410 transmits, via communication interface(s) 440, the second flight plan data to an external computing system, such as ACDM 300.

In response to transmitting the second flight data, processing circuitry 410 receives, via communication interface(s) 440 from the external computing system, an ingress point for a runway. Processing circuitry 410 may cause one of output device(s) 460 to a display an airport map, wherein the airport map includes an annotation indicating the ingress point. For example, processing circuitry 410 may cause a vertical situation display to output a map of a runway and to annotate on the map of the runway an ingress point for the runway, a threshold point for the runway, and/or a roll point for the runway. The annotation may, for example, include a label, color, symbol, special font, or any other such manner of identifying these points on the map. The vertical heads up, or other type of output device, may additionally display an amount of runway maintaining.

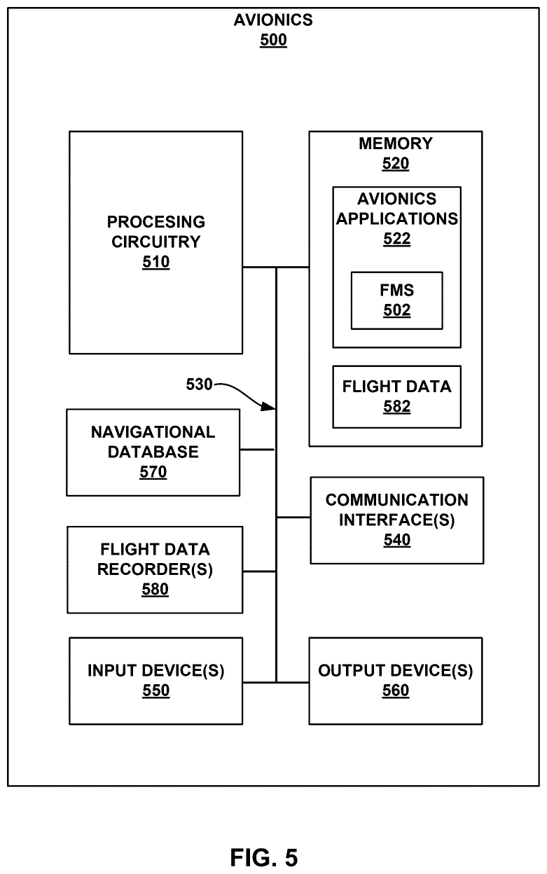

FIG. 5 illustrates an example of avionic 500. Avionics 500 is specialized computing hardware configured to store and execute avionics applications. In the example of FIG. 5, avionics 500 includes processing circuitry 510, memory 520 which stores avionics applications 522 and flight data 572, communication interface(s) 540 to communicate with other devices, such as EFB 400, input device(s) 550, output device(s) 560, navigational database 570, and flight data recorder(s) 580. The aforementioned components of avionics 500 may be connected to one another through a bus 630, which generally represents one or more busses and is intended to generically represent all the electrical and data connectivity of internal components included within avionics 500.

Processing circuitry 510 implements the functionality of and/or executes the instructions associated with avionics applications 522. Processing circuitry 510 may be implemented as any of a variety of suitable circuitry that includes a processing system, such as one or more integrated circuits, microprocessors, digital signal processors (DSPs), application specific integrated circuits (ASICs), field programmable gate arrays (FPGAs), discrete logic, software, hardware, firmware or any combinations thereof. When the techniques are implemented partially in software, avionics 500 may store instructions for the software in a suitable, non-transitory computer-readable medium (e.g., memory 520) and execute the instructions in hardware using processing circuitry 510 to perform the techniques of this disclosure.

Memory 520 is intended to generically represent all memory included within avionics 500. In some implementations, memory 520 may include a plurality of separate devices and memory units. Theses memory devices and memory units may include volatile memory, such as RAM, and/or non-volatile memory, such as ROM and storage media. Example of RAM include DRAM, including SDRAM, MRAM, RRAM. Examples of storage media include solid-state storage media (e.g., solid state drives and/or removable flash memory), optical storage media (e.g., optical discs), and/or magnetic storage media (e.g., hard disk drives). The aforementioned avionics application (shown in FIG. 5 as avionics applications 522) may be stored in any volatile and/or non-volatile memory component of memory 520.

Communication interface(s) 540 generally represents all hardware e.g., transceiver circuitry, within avionics 500 for communicating with external devices either on the ground or while in flight. Communication interface(s) 540 may facilitate communication with external devices via one or more wired and/or wireless network connections by transmitting and/or receiving signals on the one or more networks. Examples of communication interface(s) 540 include a network interface card (e.g. such as an Ethernet card), an optical transceiver, a radio frequency transceiver, a GPS receiver, or any other type of device that can send and/or receive information. Other examples of communication interface(s) 540 may include short wave radios, cellular data radios, wireless network radios, as well as USB controllers. Examples of communication interface(s) 540 for in-flight communication include a very high frequency (VHF) radio, a high frequency (HF) radio, or a satellite communication (SATCOM) radio.

Examples of communication interface(s) 540 used for data links include an aircraft communications addressing and reporting system (ACARS) for providing a digital data link system that allows for the exchange of messages between the aircraft and ground stations for purposes such as flight plan updates, weather information, and maintenance reports. Another examples of communication interface(s) 540 used for data links include controller-pilot data link communications (CPDLC) which allows air traffic control to send instructions and receive acknowledgments from pilots via text messages. Communications interface(s) 540 may also include an automatic dependent surveillance-broadcast transponder. The various examples of communications interfaces listed above represent a non-exhaustive list of the types of the types of communication interfaces that may be included in communication interface(s) 540.

Avionics 500 also includes input device(s) 550 and output device(s) 560. Examples of input device(s) 550 include control display units (CDUs) with alphanumeric keypads or touchscreens to enter flight plans, waypoints, and other necessary data. Input device(s) 550 may also include an FMS control panel for entering information to the FMS, such as route, altitude, and speed using dedicated buttons, knobs, and touchscreen interfaces. Input device(s) 550 may also include yoke or sidestick controls as well as touchscreen interfaces. Input device(s) 550 may also include rotary knobs for setting values for altitudes, speeds, and other parameters and toggle switches for selecting modes or turning systems on and off.

Examples of output device(s) 560 may include an electronic flight instrument display to provide visual representations of flight data, including altitude, airspeed, heading, and attitude. Output device(s) 560 may also include a Heads-Up Display (HUD) that projects critical flight information onto a transparent screen in the pilot's line of sight or other cockpit displays to show navigation maps, engine parameters, system statuses, and the like. Output device(s) 560 may also include a vertical situation display configured to show a vertical profile of a flight path. Output device(s) 560 may also include engine instrumentation displays to display data on engine performance, such as temperature, pressure, and revolutions per minute (RPMs). Output device(s) 560 may also include audio panels to relay communication from radios and alerts from systems to the cockpit. Output device(s) 560 may also include an FMS display to show flight plan information and performance data, as well as a traffic collision avoidance system (TCAS) display to alert pilots to nearby aircraft and potential collision threats.

The various examples of input and output devices listed above represent a non-exhaustive list of the types of the types of input and output devices that may be included in input device(s) 550 and output device(s) 560. Additionally, input and output functionality of avionics 500 may facilitated by external devices that are separate from input device(s) 550 and output device(s) 560. For example, EFB 400 may be configured to input data to and output data for avionics 500.

Avionics applications 522 represent a suite of software tools that may be used by a pilot in managing flight operations and managing the aircraft while in flight. Avionics applications 522 includes FMS 502 discussed above as well as other applications for communication, navigation, and monitoring within an aircraft. Avionics applications 522, for example, include applications for processing and displaying weather radar data and presenting essential flight information such as altitude, airspeed, attitude, and heading to a pilot. Avionics applications 522 also include various safety applications related to surveillance systems (e.g., transponders to communicate the aircraft's identity and altitude to air traffic control and other aircraft, such as automatic dependent surveillance-broadcast (ADS-B) systems that provide real-time data to air traffic control and other aircraft). Avionics applications 522 may also include the software to manage various emergency systems (e.g., an emergency locator transmitter, flight data recorder, and cockpit voice recorder) and cabin management systems (e.g., passenger infotainment systems and environmental control systems).

Navigational database 570 represents a specialized database that stores information needed by FMS 502 for the navigation and operation of an aircraft for purposes such as flight planning, route management, and ensuring safe navigation throughout a flight. Navigational database 570 may, for example, store waypoints, airways, navigational aids, airport information, standard instrument departures (SIDs) and standard terminal arrival routes (STARs), route data, and flight plans. The waypoints represent information on predefined geographical locations used for navigation, including both en-route waypoints and arrival/departure waypoints. The airways are data defining structured flight paths in the sky, including various air routes and connecting points. The navigational aids may, for example, be information on radio beacons, such as VHF Omnidirectional Range and Instrument Landing Systems that assist pilots in navigation. The airport information may, for example, include details about airports, including runway configurations, elevation, communications frequencies, and available approaches. SIDs and STARs may provide standardized paths for departures and arrivals. The route data may, for example, include information on preferred routes, including distance and estimated times. The flight data may be data regarding planned routes, altitudes, and waypoints for a specific flight. The locations of waypoints, airports, and navigational aids may, for example, be defined by geographical coordinates.

Navigational database 570 may also store information related to restrictions and procedures, performance data, and weather information. The restrictions and procedures may include airspace restrictions, no-fly zones, and specific procedures that need to be followed during flight. The performance data may include information related to aircraft performance, including altitude constraints, and speed limits. The weather information may include relevant meteorological data that might affect flight paths, such as wind patterns or turbulence zones. Navigational database 570 may be regularly updated to reflect changes in air traffic regulations, airport information, and navigational aids to ensure pilots have current information for safe and efficient flight operations.

Although not explicitly shown in FIG. 5, avionics 500 may include or be in communication with numerous other hardware components or hardware systems, such as a global positioning system (GPS) receiver, an inertial navigation system (INS) that includes gyroscopes and accelerometers to calculate position based on movement, weather radar for detecting weather patterns, engine monitoring systems, aircraft data recording systems, flight data recording systems, and other such systems. In some examples, avionics 500 may be configured to utilize inputs from a variety of specialized sensors such as altitude sensors, airspeed sensors, attitude sensors, heading sensors, GPS sensors, temperature sensors, pressure sensors, fuel sensors, weight and balance sensors, navigation sensors, environmental sensors, collision avoidance sensors, and other such sensors.

Flight data recorder(s) 580 may be configured to record, and store in memory 520, flight data 582. In some examples, flight data recorder(s) 580 may have dedicated memory, meaning the memory that stores flight data 582 is separate than, for example, the memory that stores avionics applications 522. Flight data recorder(s) 580 may include any combination of one or more flight data recorders including a quick access recorder, a deployable recorder, or a combined cockpit voice recorder and flight data recorder.

Flight data recorder(s) 580 may be configured to record flight dynamics and motion data. For example, flight data recorder(s) 580 may be configured to record the aircraft's altitude above sea level (i.e., altitude), the aircraft's speed relative to the surrounding air (i.e., airspeed), the aircraft's rate of ascent or descent (i.e., vertical speed), the direction the aircraft is pointed (i.e., heading), the aircraft's nose angle up/down and bank angle left/right (i.e., pitch and roll), the aircraft's deviation from a straight path or wind drift (i.e., yaw), and the aircraft's lateral, vertical, and longitudinal acceleration.

Flight data recorder(s) 580 may also be configured to record control surfaces and positioning data. For example, flight data recorder(s) 580 may be configured to record the aircraft's aileron position for controlling roll, the aircraft's elevator position for controlling pitch, the aircraft's rudder position for controlling yaw, the aircraft's flap positions for controlling changes in lift and drag (e.g., during takeoff, landing, and approach), the aircraft's spoiler positions for reducing lift and slowing the aircraft down, or the aircraft's slat positions for providing added lift during low-speed operations.

Flight data recorder(s) 580 may also be configured to record engine parameters. For example, flight data recorder(s) 580 may be configured to record the aircraft's engine output (e.g., engine thrust or power level), the aircraft engine's core and fan shaft speeds (i.e., N1 and N2 speeds), temperature of gases exiting the engine (e.g., exhaust gas temperature (EGT)), the rate at which fuel is consumed by each engine (i.e., fuel flow rate), oil Pressure, oil temperature, and thrust level set by the pilot (e.g., throttle position).

Flight data recorder(s) 580 may also be configured to record environmental conditions data. For example, flight data recorder(s) 580 may be configured to record outside air temperature, the presence of ice on wings or other critical surfaces, storm and weather information, and wind speed and direction.

Flight data recorder(s) 580 may also be configured to record aircraft systems and equipment data. For example, flight data recorder(s) 580 may be configured to record autopilot Status, such whether autopilot is engaged and what mode (altitude hold, heading mode, etc.) is being implemented. Flight data recorder(s) 580 may also be configured to record the position of the landing gear (e.g., up, down, or transit), brake pressure or braking force applied during landing, hydraulic pressure of braking systems, and cabin altitude and pressurization levels. Flight data recorder(s) 580 may also be configured to record electrical systems status, such as voltage, current, and operational state of systems.

Flight data recorder(s) 580 may also be configured to record flight path and navigation data, such as GPS position (e.g., latitude, longitude, and altitude coordinates), horizontal track and descent/ascent angles (i.e., flight path angle and track), speed relative to the ground (i.e., groundspeed), and navigation waypoints in the flight plan.

Flight data recorder(s) 580 may also be configured to record crew inputs. For example, flight data recorder(s) 580 may be configured to record control inputs, such as a pilot's inputs on yoke/stick, rudder pedals, and throttle. Flight data recorder(s) 580 may also be configured to record status or positions of switches (e.g., fuel pumps, anti-ice). Flight data recorder(s) 580 may also be configured to record communication controls, such as transponder codes, frequency changes, and communications status.

Flight data recorder(s) 580 may also be configured to record the status of warning and alarm systems, such as the status of alarms such as stall warnings, overspeed warnings, or terrain awareness warnings. Flight data recorder(s) 580 may also be configured to record engine and system alerts, such as malfunction notifications related to engine failures, low hydraulic pressures, or other such warnings. Flight data recorder(s) 580 may also be configured to record crew announcements and chimes.

Processing circuitry 510, executing FMS 502, may be configured to receive, via input device(s) 550, first flight plan data that configures FMS 502 to cause the aircraft to follow a flight path defined by the first flight plan data. The first flight plan data may, for example, be in the form of a .RTE or .FPL file. Processing circuitry 510 determines second flight plan data based on the first flight plan data. The second flight plan data may, for example, include one or more indicators of a takeoff weight of the aircraft. Processing circuitry 510 may extract the one or more indicators from values in the .RTE or .FPL file. Processing circuitry 510 transmits, via communication interface(s) 540, the second flight plan data to an external computing system, such as ACDM 300.

In response to transmitting the second flight data, processing circuitry 510 receives, via communication interface(s) 540 from the external computing system, an ingress point for a runway. Processing circuitry 510 may cause one of output device(s) 560 to a display an airport map, wherein the airport map includes an annotation indicating the ingress point. For example, processing circuitry 510 may cause a vertical situation display to output a map of a runway and to annotate on the map of a runway an ingress point for the runway, a threshold point for the runway, and/or a roll point for the runway. The annotation may, for example, include a label, color, symbol, special font, or any other such manner of identifying these points on the map. The vertical heads up, or other type of output device, may additionally display an amount of runway maintaining.

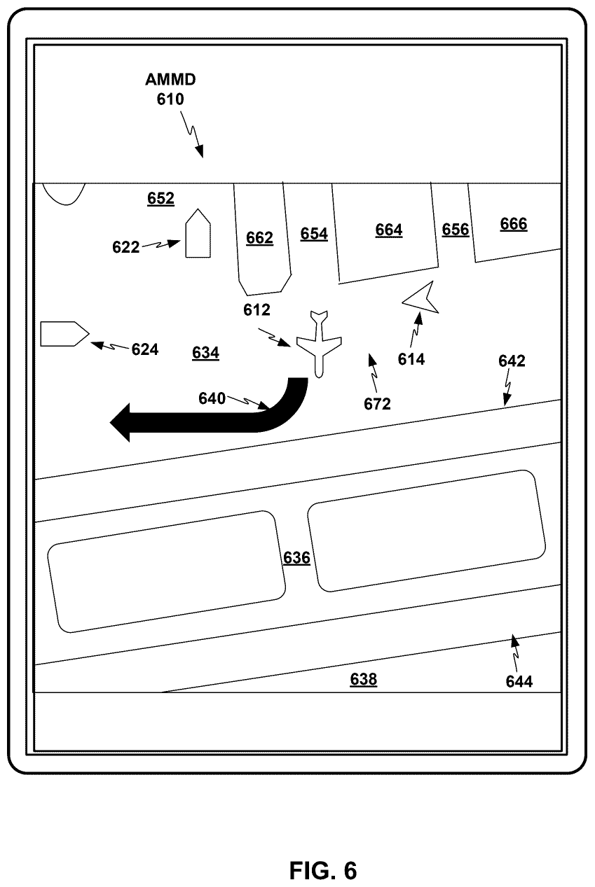

FIG. 6 is a diagram of an example graphical output display 610 of an airport ground surface map that may be implemented by a two-dimensional airport moving map display (2D AMMD) application. Display 610 may, for example, be display of EFB 500 or a display of avionics 600.

The AMMD application graphical output display 610 (or “AMMD 210”) includes representations (e.g., graphical icons) of transient surface vehicles that may be received and/or decoded by a transient surface object overlay module of an AMMD application executing on a device that provides AMMD 610. AMMD 610 thus includes a graphical icon of an ownship 612 (e.g., that may correspond to aircraft 101 if FIG. 1); graphical icons of another moving vehicle 614; and graphical icons of ground vehicles 622, 624, in the display example shown in FIG. 6.

AMMD 610 also includes representations of aerodrome guidance features, such as surface guidance markers 642 and 644. AMMD 610 may also include representations of taxiways 634, 636, and 638, and apron areas 652, 654, and 656 near airport terminal building portions 662, 664, and 666.

In the example of FIG. 6, AMMD 610 includes annotation 640. In the example of FIG. 6, the annotation takes the form of an arrow showing a path to a selected ingress point; however, numerous other types of annotations may also be used. Avionics displays use various types of annotations to show locations on maps, enhancing situational awareness and navigation for pilots. One common type of annotation is the use of arrows, as shown in FIG. 6, to indicate paths or directions to specific points of interest, such as ingress points, taxiways, or runways. These arrows may be color-coded or styled differently to convey additional information, such as priority paths or restricted areas.

Another type of annotation is the use of symbols or icons to represent different objects or locations on the map. For example, aircraft may be depicted with airplane icons, while ground vehicles may be shown with car or truck icons. Buildings, gates, and other airport infrastructure may be represented with corresponding symbols, making it easy for pilots to identify key locations at a glance. Text labels may also be used as annotations on avionics displays. These labels may provide additional information about specific locations, such as gate numbers, taxiway identifiers, or runway designations. Text labels may be dynamically updated to reflect real-time information, such as changes to taxi instructions or a change to a different ingress point. Color-coding may also be used on avionics displays. Different colors can be used to highlight various elements on the map, such as ingress points, active runways, closed taxiways, or areas under construction. Color-coding helps pilots quickly distinguish between different types of information and prioritize their actions accordingly.

Annotations may also include graphical overlays, such as shaded areas or boundary lines, to indicate specific zones or regions on the map. For example, restricted airspace, no-fly zones, or areas with specific operational constraints may be highlighted with graphical overlays, providing pilots with clear visual cues about where an aircraft may or may not operate. In addition to these static annotations, avionics displays may also incorporate dynamic annotations that change based on real-time data. For example, moving icons can represent the current positions of other aircraft or ground vehicles, while dynamic arrows can indicate the direction and speed of moving objects. These dynamic annotations provide pilots with up-to-date situational awareness, helping them make informed decisions during flight operations or during ground operations.

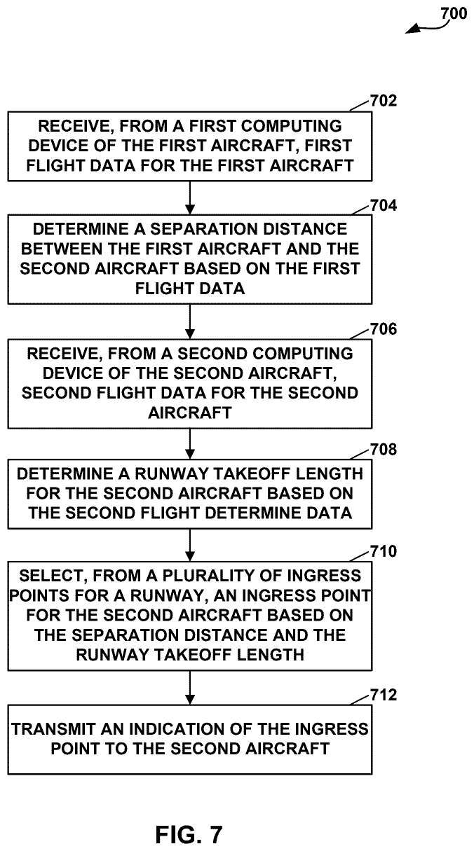

FIG. 7 is a flowchart showing an example process for selecting an ingress point for a runway from a plurality of available ingress points. Process 700 will be described with respect to a generic computing system. The generic computing system may, for example, correspond to ACDM 300 or EFB 400, but the techniques of FIG. 7 are not limited to specific systems or devices.

The computing device receives, from a first computing device of the first aircraft, first flight data for the first aircraft (702). The first computing device may, for example, be avionics of the first aircraft or be an electronic flight bag onboard the first aircraft.

The computing device determines a separation distance between the first aircraft and the second aircraft based on the first flight data (704). The computing device may, for example, determine, based on the first flight data, an actual takeoff weight of the first aircraft and determine the separation distance based on the actual takeoff weight, rather than a maximum takeoff weight, for the first aircraft. To determine the separation distance based on the actual takeoff weight of the first aircraft, the computing device may be configured to determine, based on the takeoff weight of the first aircraft, an amount of wake turbulence caused by the first aircraft and determine the separation distance based on the amount of wake turbulence caused by the first aircraft. The computing device may additionally be configured to obtain weather data from a weather source and determine the amount of wake turbulence caused by the first aircraft further based on the weather data.

The computing device receives, from a second computing device of the second aircraft, second flight data for the second aircraft (706). The second computing device may, for example, be avionics of the second aircraft or be an electronic flight bag onboard the second aircraft.

The computing device determines a runway takeoff length for the second aircraft based on the second flight data (708).

The computing device selects, from a plurality of ingress points for a runway, an ingress point for the second aircraft based on the separation distance and the runway-takeoff length (710). The computing device may be additionally configured to determine a takeoff time for the second aircraft and select the ingress point for the second aircraft further based on the takeoff time for the second aircraft. The computing device may also be configured to determine a roll point for the first aircraft and select the ingress point for the second aircraft further based on the roll point for the second aircraft.

Traffic on the runway may flow from a first end to a second end, and the plurality of ingress points for the runway may include a first ingress point that is a maximum distance from the second end and a second ingress point that is less than the maximum distance from the second end. The runway may include additional ingress points at different locations. The selected ingress point may not always be the first ingress point.

The computing device transmits an indication of the ingress point to the second aircraft (712). This transmission involves selecting appropriate file formats and communication protocols to ensure secure and efficient data exchange with the avionics of the second aircraft. The computing device may use standardized file formats such as JavaScript Object Notation (JSON) or eXtensible Markup Language (XML) to structure the data. Other formats like Comma-Separated Values (CSV) or proprietary binary formats may also be used, depending on the specific requirements and capabilities of the avionics system.

The following numbered clauses illustrate one or more aspects of the devices and techniques described in this disclosure.

Clause 1: A computer-implemented method for coordinating takeoff of a first aircraft and a second aircraft, the method comprising: receiving, from a first computing device of the first aircraft by processing circuitry of a runway management system, first flight data for the first aircraft; determining, by the processing circuitry of the runway management system, a separation distance between the first aircraft and the second aircraft based on the first flight data; receiving, from a second computing device of the second aircraft by the processing circuitry of the runway management system, second flight data for the second aircraft; determining, by the processing circuitry of the runway management system, a runway takeoff length for the second aircraft based on the second flight data; selecting, from a plurality of ingress points for a runway, an ingress point for the second aircraft based on the separation distance and the runway takeoff length; and transmitting an indication of the ingress point to the second aircraft.

Clause 2: The method of clause 1, further comprising: determining, based on the first flight data, a takeoff weight of the first aircraft; and determining the separation distance based on the takeoff weight of the first aircraft.

Clause 3: The method of clause 2, wherein determining the separation distance based on the takeoff weight of the first aircraft comprises: determining, based on the takeoff weight of the first aircraft, an amount of wake turbulence caused by the first aircraft; and determining the separation distance based on the amount of wake turbulence caused by the first aircraft.

Clause 4: The method of clause 3, further comprising: obtaining weather data from a weather source; and determining the amount of wake turbulence caused by the first aircraft further based on the weather data.

Clause 5: The method of any of clauses 1-4, further comprising: determining a takeoff time for the second aircraft; and selecting the ingress point for the second aircraft further based on the takeoff time for the second aircraft.

Clause 6: The method of any of clauses 1-5, further comprising: determining a roll point for the first aircraft; and selecting the ingress point for the second aircraft further based on the roll point for the second aircraft.

Clause 7: The method of any of clauses 1-6, wherein the second computing device comprises an avionics system of the second aircraft.

Clause 8: The method of any of clauses 1-7, wherein: traffic on the runway flows from a first end to a second end, the plurality of ingress points for the runway includes a first ingress point that is a maximum distance from the second end and a second ingress point that is less than the maximum distance from the second end, and the selected ingress point is the second ingress point.

Clause 9. A system for coordinating takeoff of a first aircraft and a second aircraft, the system comprising: one or more memories; and processing circuitry coupled to the one or more memories and configured to: receive, from a first computing device of the first aircraft, first flight data for the first aircraft; determine a separation distance between the first aircraft and the second aircraft based on the first flight data; receive, from a second computing device of the second aircraft, second flight data for the second aircraft; determine a runway takeoff length for the second aircraft based on the second flight data; select, from a plurality of ingress points for a runway, an ingress point for the second aircraft based on the separation distance and the runway takeoff length; and transmit an indication of the ingress point to the second aircraft.

Clause 10: The system of clause 9, wherein the processing circuitry is further configured to: determine, based on the first flight data, a takeoff weight of the first aircraft; and determine the separation distance based on the takeoff weight of the first aircraft.

Clause 11: The system of clause 10, wherein to determine the separation distance based on the takeoff weight of the first aircraft, the processing circuitry is further configured to: determine, based on the takeoff weight of the first aircraft, an amount of wake turbulence caused by the first aircraft; and determine the separation distance based on the amount of wake turbulence caused by the first aircraft.

Clause 12: The system of clause 11, wherein the processing circuitry is further configured to: obtain weather data from a weather source; and determine the amount of wake turbulence caused by the first aircraft further based on the weather data:

Clause 13: The system of any of clauses 9-12, wherein the processing circuitry is further configured to: determine a takeoff time for the second aircraft; and select the ingress point for the second aircraft further based on the takeoff time for the second aircraft.

Clause 14: The system of any of clauses 9-13, wherein the processing circuitry is further configured to: determine a set of taxi instructions based on the ingress point; and transmit the set of taxi instructions to the second aircraft.

Clause 15: The system of any of clauses 9-14, wherein the second computing device comprises an avionics system of the second aircraft.

Clause 16: The system of any of clauses 9-15 wherein: traffic on the runway flows from a first end to a second end, the plurality of ingress points for the runway includes a first ingress point that is a maximum distance from the second end and a second ingress point that is less than the maximum distance from the second end, and the selected ingress point is the second ingress point.

Clause 17: A system of an aircraft, the system comprising: one or more memories; and processing circuitry coupled to the one or more memories and configured to: receive, via an input device, first flight plan data, wherein the first flight plan data configures a flight management system of the avionics to cause the aircraft to follow a flight path defined by the first flight plan data; determine second flight plan data based on the first flight plan data, wherein the second flight plan data comprises one or more indicators of a takeoff weight of the aircraft; transmit the second flight plan data to an external computing system; in response to transmitting the second flight data, receive from the external computing system, an indication of an ingress point for a runway; and cause a display to output an airport map, wherein the airport map includes an annotation identifying the ingress point.

Clause 18: The system of clause 17, wherein the display comprises a vertical situation display.

Clause 19: The system of clause 17 or 18, wherein the processing circuitry is further configured to: in response to transmitting the second flight data, receive from the external computing system, a set of milestone times, wherein the set of milestone times includes a target time for the aircraft to lift off from the runway.

Clause 20: The system of any of clauses 17-19, wherein the system comprises one of an avionics system of the aircraft or an electronic flight bag in data communication with the avionics system of the aircraft.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A computer-implemented method for coordinating takeoff of a first aircraft and a second aircraft, the method comprising:
receiving, from a first computing device of the first aircraft by processing circuitry of a runway management system, first flight data for the first aircraft;
determining, by the processing circuitry of the runway management system, a separation distance between the first aircraft and the second aircraft based on the first flight data;
receiving, from a second computing device of the second aircraft by the processing circuitry of the runway management system, second flight data for the second aircraft;
determining, by the processing circuitry of the runway management system, a runway takeoff length for the second aircraft based on the second flight data;
selecting, from a plurality of ingress points for a runway, an ingress point for the second aircraft based on the separation distance and the runway takeoff length; and
transmitting an indication of the ingress point to the second aircraft.

2. The method of claim 1, further comprising:
determining, based on the first flight data, a takeoff weight of the first aircraft; and
determining the separation distance based on the takeoff weight of the first aircraft.

3. The method of claim 2, wherein determining the separation distance based on the takeoff weight of the first aircraft comprises:
determining, based on the takeoff weight of the first aircraft, an amount of wake turbulence caused by the first aircraft; and
determining the separation distance based on the amount of wake turbulence caused by the first aircraft.

4. The method of claim 3, further comprising:
obtaining weather data from a weather source; and
determining the amount of wake turbulence caused by the first aircraft further based on the weather data.

5. The method of claim 1, further comprising:
determining a takeoff time for the second aircraft; and
selecting the ingress point for the second aircraft further based on the takeoff time for the second aircraft.

6. The method of claim 1, further comprising:
determining a roll point for the first aircraft; and
selecting the ingress point for the second aircraft further based on the roll point for the second aircraft.

7. The method of claim 1, wherein the second computing device comprises an avionics system of the second aircraft.

8. The method of claim 1, wherein:
traffic on the runway flows from a first end to a second end,
the plurality of ingress points for the runway includes a first ingress point that is a maximum distance from the second end and a second ingress point that is less than the maximum distance from the second end, and
the selected ingress point is the second ingress point.

9. A system for coordinating takeoff of a first aircraft and a second aircraft, the system comprising:
one or more memories; and
processing circuitry coupled to the one or more memories and configured to:
receive, from a first computing device of the first aircraft, first flight data for the first aircraft;
determine a separation distance between the first aircraft and the second aircraft based on the first flight data;
receive, from a second computing device of the second aircraft, second flight data for the second aircraft;
determine a runway takeoff length for the second aircraft based on the second flight data;
select, from a plurality of ingress points for a runway, an ingress point for the second aircraft based on the separation distance and the runway takeoff length; and
transmit an indication of the ingress point to the second aircraft.

10. The system of claim 9, wherein the processing circuitry is further configured to:
determine, based on the first flight data, a takeoff weight of the first aircraft; and
determine the separation distance based on the takeoff weight of the first aircraft.

11. The system of claim 10, wherein to determine the separation distance based on the takeoff weight of the first aircraft, the processing circuitry is further configured to:
determine, based on the takeoff weight of the first aircraft, an amount of wake turbulence caused by the first aircraft; and
determine the separation distance based on the amount of wake turbulence caused by the first aircraft.

12. The system of claim 11, wherein the processing circuitry is further configured to:
obtain weather data from a weather source; and
determine the amount of wake turbulence caused by the first aircraft further based on the weather data.

13. The system of claim 9, wherein the processing circuitry is further configured to:
determine a takeoff time for the second aircraft; and
select the ingress point for the second aircraft further based on the takeoff time for the second aircraft.

14. The system of claim 9, wherein the processing circuitry is further configured to:
determine a set of taxi instructions based on the ingress point; and
transmit the set of taxi instructions to the second aircraft.

15. The system of claim 9, wherein the second computing device comprises an avionics system of the second aircraft.

16. The system of claim 9, wherein:
traffic on the runway flows from a first end to a second end,
the plurality of ingress points for the runway includes a first ingress point that is a maximum distance from the second end and a second ingress point that is less than the maximum distance from the second end, and
the selected ingress point is the second ingress point.

17. A system of an aircraft, the system comprising:
one or more memories; and
processing circuitry coupled to the one or more memories and configured to:
receive, via an input device, first flight plan data, wherein the first flight plan data configures a flight management system of the avionics to cause the aircraft to follow a flight path defined by the first flight plan data;
determine second flight plan data based on the first flight plan data, wherein the second flight plan data comprises one or more indicators of a takeoff weight of the aircraft;
transmit the second flight plan data to an external computing system;
in response to transmitting the second flight data, receive from the external computing system, an indication of an ingress point for a runway; and
cause a display to output an airport map, wherein the airport map includes an annotation identifying the ingress point.

18. The system of claim 17, wherein the display comprises a vertical situation display.

19. The system of claim 17, wherein the processing circuitry is further configured to:
in response to transmitting the second flight data, receive from the external computing system, a set of milestone times, wherein the set of milestone times includes a target time for the aircraft to lift off from the runway.

20. The system of claim 17, wherein the system comprises one of an avionics system of the aircraft or an electronic flight bag in data communication with the avionics system of the aircraft.
